(19) United States
(12) Patent Application Publication
(10) Pub. No.: US 2015/0125634 A1
(43) Pub. Date: May 7, 2015

(54) GLASS VACUUM INSULATING PANELS AND METHODS

(71) Applicant: Corning Incorporated, Corning, NY (US)

(72) Inventor: Ian Gordon Jefferson, Corning, NY (US)

(21) Appl. No.: 14/381,429

(22) PCT Filed: Feb. 27, 2013
(86) PCT No.: PCT/US13/28091

§ 371 Date: Aug. 27, 2014

Related U.S. Application Data
(60) Provisional application No. 61/604,703, filed on Feb. 29, 2012.

(51) Int. Cl. F24J 2/05; E06B 3/677; E06B 3/673; E06B 1/36; F16L 59/065; E06B 3/66

(52) U.S. Cl. CPC F24J 2/05; F16L 59/065; E06B 3/6612; E06B 3/673; E06B 1/36; E06B 3/6775
USPC 428/34; 126/652; 126/714; 52/745.16; 52/204.593; 156/109; 29/890.033

(57) ABSTRACT

A glass vacuum insulating panel comprises at least one sheet of glass including a first sheet portion with a first plurality of attachment locations and a second sheet portion with a second plurality of attachment locations. The first sheet portion and the second sheet portion each extend along a plane of the glass vacuum insulating panel. An insulating space is hermetically sealed between the first sheet portion and the second sheet portion, wherein the insulating space includes an absolute pressure of less than about 10 kPa. Each of the first plurality of attachment locations is attached to a corresponding one of the second plurality of attachment locations to form a plurality of integral attachment areas that are spaced apart in a pattern along the plane of the glass vacuum insulating panel. Methods of making a glass vacuum insulating panel are also provided.

### CROSS-REFERENCE TO RELATED APPLICATIONS

This application claims the benefit of priority under 35 U.S.C. §119 of U.S. Provisional Application Ser. No. 61/604,703, filed on Feb. 29, 2012, the content of which is relied upon and incorporated herein by reference in its entirety.

### FIELD

The present disclosure relates generally to insulating panels and methods of making insulating panels and, more particularly, to glass vacuum insulating panels and methods of making glass vacuum insulating panels.

### BACKGROUND

Glass vacuum insulating panels are known for use to provide insulation of an inside area from an outside area. Such insulating panels are known to include a vacuum space between a first sheet of glass and a second sheet of glass.

### SUMMARY

In one aspect, a glass vacuum insulating panel comprises at least one sheet of glass including a first sheet portion with a first plurality of attachment locations and a second sheet portion with a second plurality of attachment locations. The first sheet portion and the second sheet portion each extend along a plane of the glass vacuum insulating panel. An insulating space is hermetically sealed between the first sheet portion and the second sheet portion, wherein the insulating space includes an absolute pressure of less than about 10 kPa and contains essentially no amount of discharge or ionizable gas within the insulating space. Each of the first plurality of attachment locations is fritlessly attached to a corresponding one of the second plurality of attachment locations to form a plurality of integral fritless attachment areas that are spaced apart in a pattern along the plane of the glass vacuum insulating panel.

In one example of the aspect, each of the plurality of integral fritless attachment areas extends as an elongated segment area along the plane of the glass vacuum insulating panel.

In another example of the aspect, each elongated segment area is substantially linear.

In yet another example of the aspect, each of the plurality of integral fritless attachment areas comprises a point area.

In another example aspect, a glass vacuum insulating panel comprises at least one sheet of glass including a first sheet portion with a first plurality of attachment locations and a second sheet portion with a second plurality of attachment locations. The first sheet portion and the second sheet portion each extend along a plane of the glass vacuum insulating panel. An insulating space is hermetically sealed between the first sheet portion and the second sheet portion, wherein the insulating space includes an absolute pressure of less than about 10 kPa and contains essentially no amount of discharge or ionizable gas within the insulating space. Each of the first plurality of attachment locations is attached to a corresponding one of the second plurality of attachment locations to form a plurality of integral attachment areas that are spaced apart in a pattern along the plane of the glass vacuum insulating panel. At least one of the first sheet portion and the second sheet portion includes at least one outwardly facing nonplanar surface portion at each integral attachment area.

In one example of the aspect, each of the first plurality of attachment locations and the corresponding one of the second plurality of attachment locations converge toward one another to form the corresponding integral attachment area.

In another example of the aspect, the insulating space comprises at least one insulating space channel.

In another example of the aspect, the plurality of integral attachment areas are each fritless.

In yet another example of the aspect, at least one of the first sheet portion and the second sheet portion includes an outwardly facing surface including the outwardly facing nonplanar surface portions. The outwardly facing surface defines a pattern of bulbous portions defined between a corresponding set of the plurality of integral attachment areas.

In another example aspect, a housing structure includes the glass vacuum insulating panel in accordance with the aspects or one of the examples aspects of the glass vacuum insulating panel discussed above. In such examples, the housing structure includes a wall with the glass vacuum insulating panel. An interior area of the housing structure is at least partially insulated by the glass vacuum insulating panel.

In another example aspect, a solar absorber apparatus includes the glass vacuum insulating panel in accordance with the aspects or one of the examples of the aspects of the glass vacuum insulating panel discussed above. In such examples, the solar absorber apparatus includes an absorber device configured to absorb solar energy. The absorber device is at least partially insulated with the glass vacuum insulating panel. A heat transfer device is configured to remove absorbed energy from the absorber device.

In another example aspect, a method of making a glass vacuum insulating panel comprises the step (I) of providing at least one sheet of glass including a first sheet portion with a first plurality of attachment locations and a second sheet portion with a second plurality of attachment locations. The method further includes the step (II) of fritlessly engaging each of the first plurality of attachment locations to a corresponding one of the second plurality of attachment locations to form a plurality of integral fritless attachment areas that are spaced apart in a pattern along a plane such that the first sheet portion and the second sheet portion are integrally attached to one another with an insulating space sealed between the first sheet portion and the second sheet portion. The method further includes the steps (III) of providing the insulating space with an absolute pressure of less than about 10 kPa and the step (IV) of hermetically sealing the insulating space with the absolute pressure of less than about 10 kPa, wherein the insulating space contains essentially no amount of discharge or ionizable gas.

In one example of the aspect, the method forms at least one of the first sheet portion and the second sheet portion with an outwardly facing surface defining a pattern of bulbous portions defined between a corresponding set of the plurality of integral attachment areas.

In another example of the aspect, the method forms each of the bulbous portions as an outwardly convex surface portion.

In yet another example of the aspect, the method forms each of the bulbous portions as a pyramidal surface portion.

In still another example of the aspect, the method forms the insulating space as at least one insulating channel.

In one example aspect, a method of making a housing structure includes the method of making a glass vacuum insulating panel in accordance with the example aspect or the examples of the aspect discussed above and further comprising the step of providing a wall. The method further includes the step of installing the glass vacuum insulating panel with respect to the wall, wherein an interior area of the housing structure is at least partially insulated by the glass vacuum insulating panel.

In another example aspect, a method of making a solar absorber apparatus includes the method of making a glass vacuum insulating panel in accordance with the example aspect or the examples of the aspect discussed above and further comprising the step of providing an absorber device configured to absorb solar energy. The method further includes the steps of at least partially insulating the absorber device with the glass vacuum insulating panel; and operably connecting a heat transfer device to the absorber device such that the heat transfer device is configured to remove absorbed energy from the absorber device.

### BRIEF DESCRIPTION OF THE DRAWINGS

These and other features, aspects and advantages of the present invention are better understood when the following detailed description of the invention is read with reference to the accompanying drawings, in which:

FIG. 1 is an example glass vacuum insulating panel in accordance with the disclosure;

FIG. 2 is a cross-sectional view of the glass vacuum insulating panel along line 2-2 of FIG. 1;

FIG. 3 is another example glass vacuum insulating panel in accordance with the disclosure;

FIG. 4 is a cross-sectional view of the glass vacuum insulating panel along line 4-4 of FIG. 3;

FIG. 5 is a cross-sectional view of the glass vacuum insulating panel along line 5-5 of FIG. 3;

FIG. 6 is another example glass vacuum insulating panel in accordance with the disclosure;

FIG. 7 is a cross-sectional view of the glass vacuum insulating panel along line 7-7 of FIG. 6;

FIG. 8 is another example glass vacuum insulating panel in accordance with the disclosure;

FIG. 9 is a cross-sectional view of the glass vacuum insulating panel along line 9-9 of FIG. 8;

FIG. 10 is a cross-sectional view of the glass vacuum insulating panel along line 10-10 of FIG. 8;

FIG. 11 is a schematic view of an example panel arrangement;

FIG. 12 illustrates example steps of making a glass vacuum insulating panel;

FIGS. 13 and 14 illustrate alternative example steps of making a glass vacuum insulating panel;

FIG. 15 illustrates another example step of making a glass vacuum insulating panel;

FIG. 16 illustrates an example housing structure with an example glass vacuum insulating panel; and

FIG. 17 illustrates an example solar absorber apparatus including an example glass vacuum insulating panel.

### DETAILED DESCRIPTION

The present invention will now be described more fully hereinafter with reference to the accompanying drawings in which example embodiments of the invention are shown. Whenever possible, the same reference numerals are used throughout the drawings to refer to the same or like parts. However, this invention may be embodied in many different forms and should not be construed as limited to the embodiments set forth herein. These example embodiments are provided so that this disclosure will be both thorough and complete, and will fully convey the scope of the invention to those skilled in the art.

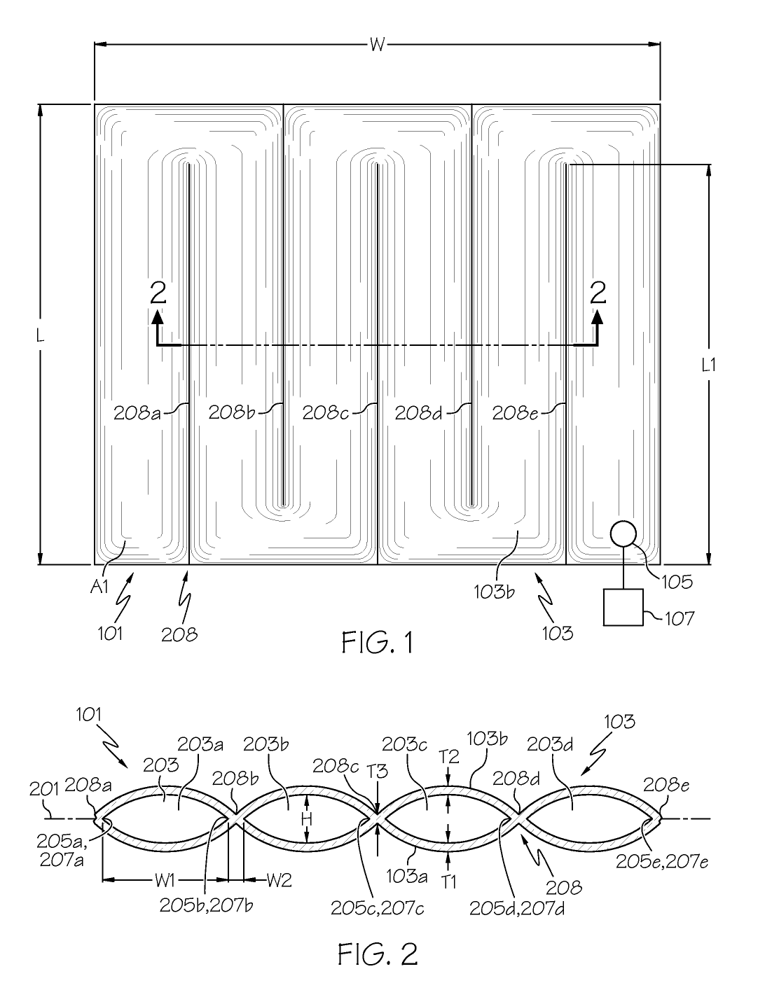

FIG. 1 illustrates a glass vacuum insulating panel 101 in accordance with aspects of the present disclosure. The glass vacuum insulating panel 101 can include an overall area defined a periphery, such as an outer periphery, of the glass vacuum insulating panel 101. As shown, the glass vacuum insulating panel 101 can comprise a rectangular panel having an overall area defined by the product of a length “L” and width “W” of the panel. In further examples, the glass vacuum insulating panel 101 may comprise other alternative shapes such as a polygonal shape with three or more sides and, in further examples, may comprise circular, elliptical or other shapes.

As shown in FIG. 2, the glass vacuum insulating panel 101 can include at least one sheet of glass 103 including a first sheet portion 103a and a second sheet portion 103b. In one example, two sheets of glass may be provided wherein one sheet of glass forms the first sheet portion 103a and the other sheet of glass forms the second sheet portion 103b. In further examples, a single sheet of glass may be provided that, for example, may be folded over itself such that one folded portion forms the first sheet portion 103a and the other folded portion forms the second sheet portion 103b.

The first sheet portion 103a and the second sheet portion 103b each extend along a plane 201 of the glass vacuum insulating panel 101. The illustrated plane is substantially flat although the plane may be curved or otherwise shaped in further examples depending on the particular application. As further illustrated, an insulating space 203 is hermetically sealed between the first sheet portion 103a and the second sheet portion 103b. In one example, prior to hermetic sealing, the insulating space 203 can be provided with an absolute pressure of less than about 10 kPa, such as from about 1×10⁻¹⁰ Pa to about 10 kPa, such as from about 1×10⁻⁷ Pa to about 4 kPa, such as from about 1 kPa to about 4 kPa such as about 3.3 kPa. In one example, the insulating space 203 can be at least partially or substantially evacuated in order to achieve the desired absolute pressure. Providing an absolute pressure within the ranges discussed above can be effective to help enhance the insulating properties of the glass vacuum insulating panel 101. Indeed, the at least partial evacuated insulating space 203 can reduce, such as prevent, conduction and/or convection of heat between the first sheet portion 103a and the second sheet portion 103b.

Still further, the insulating space contains essentially no amount of discharge or ionizable gas within the insulating space 203. In one example, essentially no amount of discharge or ionizable gas can be considered no amount of discharge or ionizable gas. In further examples, essentially no amount of discharge or ionizable gas can be considered any amount of gas that is less than an amount of gas necessary to allow ionization or activation of the gas by one or more electrodes to cause light to be emitted by the discharge or ionizable gas. As such, the glass vacuum insulating panel 101 of the disclosure has no application as a device that emits light from any gas within the insulating space 203. Indeed, the insulating space 203 is not backfilled with an amount of discharge or ionizable gas sufficient to allow ionization or activation of the gas by electrodes. Providing the insulating space 203 with essentially no amount of discharge or ionizable gas can be beneficial, for example, to help reduce costs of producing the glass vacuum insulated panel.

As shown, for example, in FIGS. 2 and 12-14, the first sheet portion 103a can be provided with a first plurality of attachment locations 205a-e. Moreover, as shown in FIGS. 2, 12 and 14, the second sheet portion 103b can be provided with a second plurality of attachment locations 207a-e. Each of the first plurality of attachment locations 205a-e is attached to a corresponding one of the second plurality of attachment locations 207a-e to form a plurality of integral attachment areas 208 that are spaced apart in a pattern along the plane 201 of the glass vacuum insulating panel 101.

Integrally attaching the attachment locations together to form the integral attachment areas can be performed with a frit or other material added to facilitate integral attachment between the locations. For example, a frit may be provided and subsequently heated with a laser or other heating devise such that the frit integrally joins the attachment locations together.

In another example, each of the first plurality of attachment locations 205a-e is fritlessly attached to a corresponding one of the second plurality of attachment locations 207a-e to form a plurality of integral fritless attachment areas 208 that are spaced apart in a pattern along the plane 201 of the glass vacuum insulating panel 101. In such examples, the attachment locations of the respective first sheet portion 103a, and second sheet portion 103b can be configured to integrate together without additional material (e.g., frit material) such that the respective facing surfaces of the first sheet portion and the second sheet portion integrate together to form the integral fritless attachment areas 208. Providing fritless attachment of the attachment locations can reduce costs associated with manufacturing the glass vacuum insulating panels.

Whether or not fritless, various numbers of integral attachment areas 208 can be spaced apart from one another along the width “W” and/or length “L” of the glass vacuum insulated panel. Providing a sufficient number spaced apart integral attachment areas 208 per unit length or width can help strengthen the glass vacuum insulated panel. In addition, the integral attachment areas 208 may be provided in a wide range of structural configurations. Indeed, the integral attachment areas 208 can be provided with desirable structural configurations to help strengthen the glass vacuum insulated panel. Strengthening the vacuum insulated panel can be desirable to help prevent structural failure of the panel under its own weight and/or from external forces applied to the panel during manufacture, assembly or use of the panel.

The effective area of the integral attachment areas 208 can also be minimized to reduce heat loss through the glass vacuum insulated panel while still providing the integral attachment areas 208 in a sufficient number and with a sufficient structural configuration to enhance the strength of the glass vacuum insulated panel. Heat transfer will naturally occur at a higher rate through the integral attachment areas by conduction when compared to heat transfer between the first sheet portion 103a and second sheet portion 103b through the insulating space 203. In order to minimize heat loss, the effective area of the integral attachment areas 208 can be minimized when compared to the overall area of the glass vacuum insulating panel 101.

FIGS. 1 and 2 illustrate just one example of integral attachment areas 208 that may be used in accordance with aspects of the disclosure. Although not required in all examples, the integral attachment areas 208 shown in FIGS. 1 and 2 comprise integral fritless attachment areas 208a-e. As shown, the integral attachment areas 208 can extend as elongated segment areas 208a-e along the plane 201 of the glass vacuum insulating panel 101. As shown, the elongated segment areas 208a-e can comprise a continuous seam where the first attachment locations 205a-e are respectively integrally attached to the second attachment locations 207a-e along the length “L1” of the elongated segment areas 208a-e. In the illustrated example, the length “L1” of each of the elongated segment areas 208a-e are substantially identical to one another although one or more of the lengths may be different in further examples.

As shown each elongated segment area 208a-e can be substantially linear although further examples may provide the elongated segments areas 208a-e with serpentine, curvilinear, rectilinear, and/or other shapes. As further illustrated, each elongated segment area 208a-e can be substantially parallel to one another although one or more of the elongated segment areas 208a-e may be angled with respect to one another in further examples.

Example embodiments of the disclosure can provide the insulating space as at least one insulating channel. For example, the illustrated insulating space 203 comprises a plurality of insulating space channels. The four illustrated insulating channels 203a-d shown in FIG. 2 are offset from one another by a respective integral segment area 208b-d. The plurality of insulating space channels 203a-d are parallel with one another although one or more of the insulating space channels 203a-d may be oriented at an angle with respect to one or more of the remaining insulating space channels in further examples. Moreover, as shown, the insulating space channels 203a-d are substantially linear although further examples may provide the insulating space channels 203a-d with serpentine, curvilinear, rectilinear, and/or other shapes.

As further shown in FIG. 1, the insulating space channels 203a-d are each connected end to end in a serpentine pattern. As such, a single evacuation port 105 maybe provided that allows all of the insulating space channels 203a-d to be efficiently evacuated at one location. Although not shown, in further embodiments, one or more of the insulating space channels may be isolated from one another.

As mentioned previously, the effective area of the integral attachment areas 208 can be minimized when compared to the overall area of the glass vacuum insulating panel 101. In the illustrative example of FIG. 1, the overall area “A1” of the glass vacuum insulating panel 101 comprises the product of the length “L” and the width “W”, i.e., A1=L·W. The effective area “A2” of the integral attachment areas 208 can be considered the cross sectional area (e.g., along plane 201) of each of the integral attachment areas 208 added together. For example, the effective area “Aa” of the first elongated segment area 208a comprises the product of the length “L1” of the first elongated segment area 208a and the width “W2”, i.e., Aa=L1·W2. The areas Aa, Ab, Ac, Ad, Ae can likewise by calculated and added together to achieve the overall effective area “A2” of the integral attachment areas 208. In one example, the ratio of the effective area “A2” relative to the overall area “A1” can be minimized to reduce heat loss through the glass vacuum insulating panel 101 while still being sufficiently high to provide the desired structural integrity.

As shown in FIG. 2, the insulating space channels 203a-d may each have a substantial curvilinear periphery, although rectilinear peripheral configurations or other shapes may be provided in further examples. In the illustrated example, corresponding outer convex segments of the first sheet portion and the second sheet portion can cooperate to form the interior area. Providing outer convex segments may enhance the structural integrity of an under-pressure condition of the insulating space channels. For instance, as shown, the cross-sectional area of the insulating space channels taken perpendicular to the channel axis has a substantial rounded shape, such as the substantially elliptical shape illustrated in FIG. 2. Each cross-sectional area can have a width “W1” and height “H” with a wide variety of ranges depending on the particular application. In one example, the height “H” can range from about 1 mm to about 80 mm and the ratio of (W1/H) can range from about 0.5 to about 30, such as from about 5 to about 25, such as from about 10 to about 20.

As further shown in FIG. 1, as with all of the embodiments of the disclosure presented through the application, the thickness “T1” of the first sheet portion 103a can be substantially identical to the thickness “T2” of the second sheet portion 103b although different thicknesses may be provided in further examples. Providing substantial identical thicknesses may be desirable to minimize glass material and weight of the glass vacuum insulated panel. In further examples, one of the glass sheet portions may be thicker than the other glass sheet portion to enhance the structural integrity of that side of the panel. For example, in certain embodiments, the panel may be installed in a manner wherein one side is exposed to the external environment. In such an example, it may be desirable to increase the thickness of the sheet portion that will be facing the external environment conditions. In one example the thickness “T1” and/or “T2” can be from about 0.2 mm to about 3 mm, such as from about 1 mm to about 3 mm although other thicknesses may be provided in further examples. Moreover, the thickness “T3” of the integral attachment areas 208 throughout the application can be a multiple of the thickness T1 and/or T2. For example, the thickness T3 can be within a range of from about the thickness T1 to about twice the thickness T1. In addition or alternatively, T3 can be within a range of from about the thickness T2 to about twice the thickness T2.

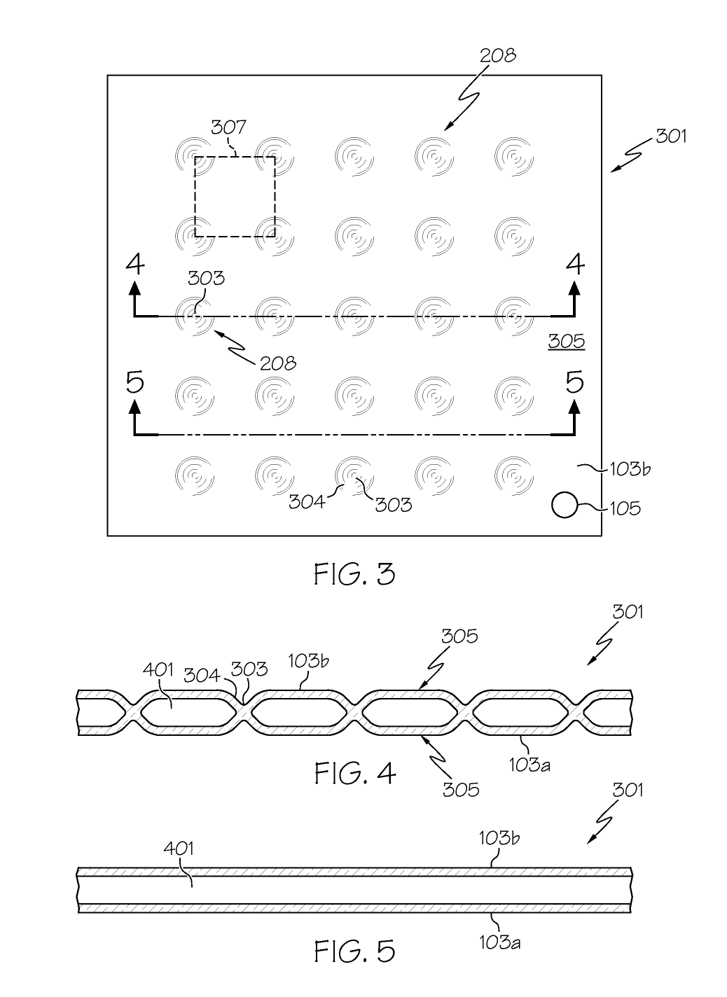

FIGS. 3-5 illustrate another example of a glass vacuum insulating panel 301 in accordance with examples of the disclosure. As shown, the plurality of attachment areas 208 (e.g., integral fritless attachment areas) can comprise a point area 303. A point area 303 is an attachment area centered about a point that does not substantially extend as an elongated attachment area. Other than shown, the point area 303 can have similar or identical characteristics as the integral attachment areas 208 discussed with respect to the respective integral segment areas 208a-e mentioned above.

The integral attachment areas 208 (e.g., integral fritless attachment areas) can be provided wherein at least one of the first sheet portion 103a and the second sheet portion 103b includes at least one outwardly facing nonplanar surface portion at each integral attachment area. As discussed above, with respect to FIGS. 1-2, the outwardly facing nonplanar surface portion can comprise the outwardly convex segments of the sheet portions that define the insulating space segments. As shown in FIGS. 3 and 4, the nonplanar surface portion, can comprise a dimple portion 304 on each surface wherein the remaining surface portions 305 may optionally comprise a substantially flat surface. Providing the integral attachment areas 208 as point areas 303 can reduce the ratio of the effective area “A2” relative to the overall area “A1” (A2/A1), and therefore minimize the heat loss through the glass vacuum insulated panel. Indeed, as shown in FIGS. 4 and 5, the insulating area 401 can be maximized while the area associated with the point areas 303 can be minimized.

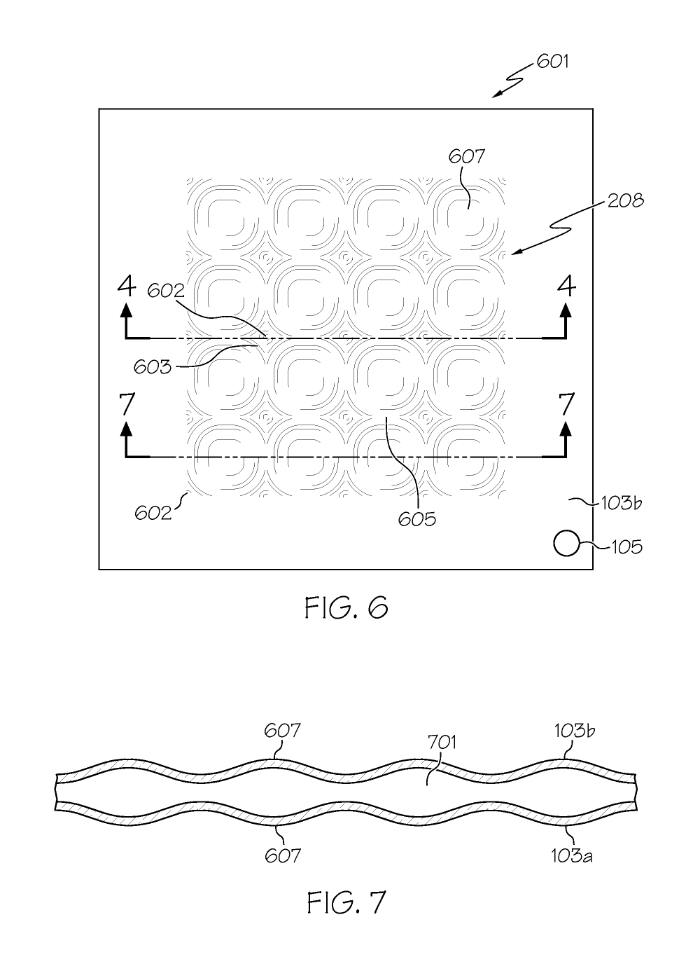

FIGS. 6 and 7 illustrate another example of a glass vacuum insulating panel 601 in accordance with examples of the disclosure. As shown, the plurality of attachment areas 208 can optionally have a cross section along line 4-4 of FIG. 6 that is substantially identical to the cross section shown in FIG. 4. As such, the glass vacuum insulating panel 601 can likewise have attachment areas in the form of a point area 602 Other than shown, the attachment areas 208 of FIG. 6 can have similar or identical characteristics as the integral attachment areas 208 discussed with respect to the respective integral segment areas 208a-e discussed above.

As shown in FIG. 2, the integral attachment areas 208 (e.g., integral fritless attachment areas) can be provided wherein at least one of the first sheet portion 103a and the second sheet portion 103b includes at least one outwardly facing nonplanar surface portion at each integral attachment area. As shown in FIG. 6, the nonplanar surface portion, can comprise a dimple portion 603 on each surface wherein segments 605 between corresponding dimple portions 603 may comprise substantially straight segments although curved segments may be provided in further examples. As with FIGS. 3-5 above, providing the integral attachment areas 208 as point areas 602 can reduce the ratio of the effective area “A2” relative to the overall area “A1” (A2/A1) and thereby minimize heat loss through the glass vacuum insulated panel. Indeed, as shown in FIG. 7, the insulating area 701 can be maximized while the area associated with the point areas 602 can be minimized.

As further shown in FIGS. 6 and 7, the outwardly facing nonplanar surface portions can also define a pattern of bulbous portions defined between a corresponding set of the plurality of point areas 602. As shown, the bulbous portions can comprise substantially convex surface areas 607. The convex surface areas can be designed to help strengthen the glass panel when compared to other designs.

FIGS. 8-10 illustrate another example of a glass vacuum insulating panel 801 in accordance with further examples of the disclosure. As shown, the plurality of attachment areas 208 can comprise a point area 803. Other than shown, the attachment areas 208 of FIGS. 8-10 can have similar or identical characteristics as the integral attachment areas 208 discussed with respect to the respective integral segment areas 208a-e discussed above.

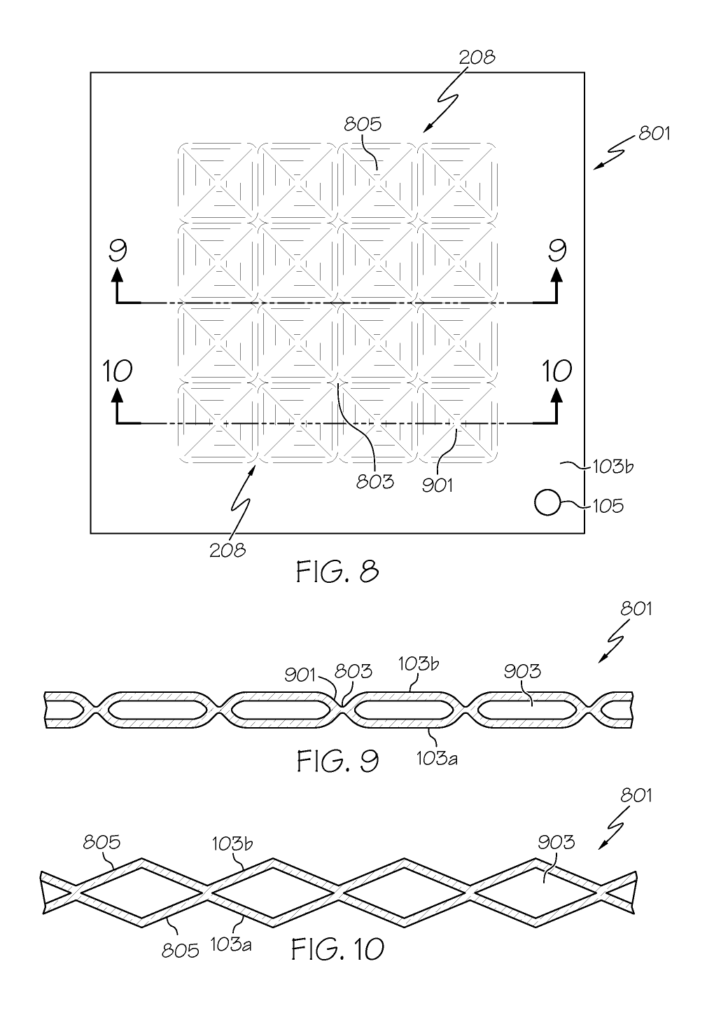

As shown in FIG. 8, the integral attachment areas 208 (e.g., integral fritless attachment areas) can be provided wherein at least one of the first sheet portion 103a and the second sheet portion 103b includes at least one outwardly facing nonplanar surface portion at each integral attachment area. As shown in FIGS. 8 and 9, the nonplanar surface portion can comprise a dimple portion 901 on each surface wherein segments between corresponding point areas 803 may comprise substantially straight segments although curved segments may be provided in further examples. As with FIGS. 3-5 above, providing the integral attachment areas 208 as point areas 803 can reduce the ratio of the effective area “A2” relative to the overall area “A1” (A2/A1) and thereby minimize heat loss through the glass vacuum insulated panel. Indeed, as shown in FIGS. 9 and 10, the insulating area 903 can be maximized while the area associated with the point areas 803 can be minimized.

As further shown in FIGS. 8 and 10, the outwardly facing nonplanar surface portions can also define a pattern of bulbous portions defined between a corresponding set of the plurality of point areas 803. As shown, the bulbous portions can comprise substantially pyramidal surface areas 805. The pyramidal surface areas can be designed to help strengthen the glass panel when compared to other designs.

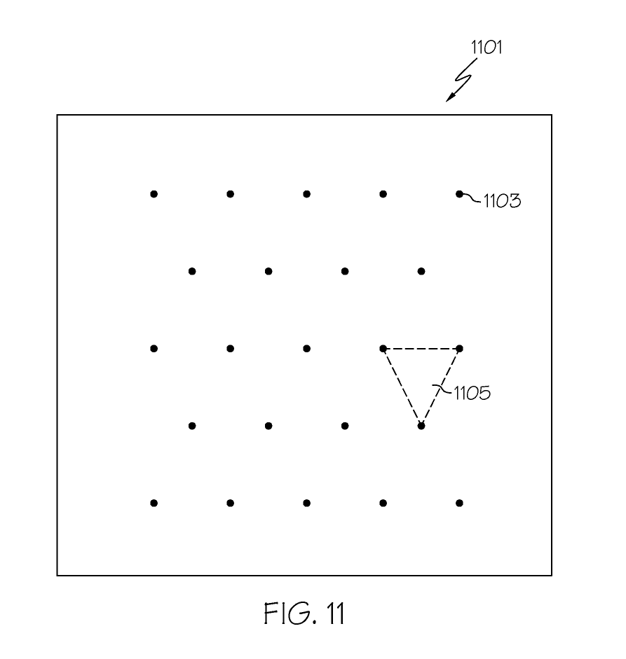

FIGS. 3-10 above discuss just a limited number of multiple possible embodiments of a vacuum glass insulated panel wherein the integral attachment areas (e.g., integral fritless attachment areas) comprise point areas 303, 602, 803. As shown, the point areas can be aligned as a matrix of point areas where each of the point areas are aligned along corresponding rows and columns, where each point area within each row of the matrix is aligned along one of the columns of the matrix. FIG. 11 demonstrates a schematic view of a panel arrangement 1101 wherein every other row is offset from the previous row such that point areas 1103 of every other row are aligned along common columns. Providing the panel arrangement 1101 of FIG. 11 can provide a triangular area 1105 bound by a respective three of the point areas 1103 compared with the rectangular (e.g., square) areas 307 bound by a respective four of the point areas 303 shown in FIG. 3. The triangular area may be provided to increase the structural integrity of the panel and the arrangement of point areas can be provided for any of the embodiments of FIGS. 3-10. As such, FIG. 3 can be provided with the panel arrangement 1101 such that a plurality of triangular planar portions (rather than the rectangular planar portions shown in FIG. 3) are provided between the point areas 1103. Furthermore, FIG. 6 can be provided with the panel arrangement 1101 such that a plurality of triangular convex segments (rather than the rectangular pillow-shaped portions shown in FIG. 6) are provided between the point areas 1103. Still further, FIG. 8 can be provided with the panel arrangement 1101 such that the pyramidal shapes comprise triangular pyramids rather than rectangular pyramids.

Each of the embodiments disclosed herein can provide each of the first plurality of attachment locations and the corresponding one of the second plurality of attachment locations converge toward one another to form the corresponding integral attachment area. For example, as shown in FIGS. 2, 4, and 9, each attachment location of each of the sheet portions 103a, 103b converge toward one another to the respective integral attachment area 208.

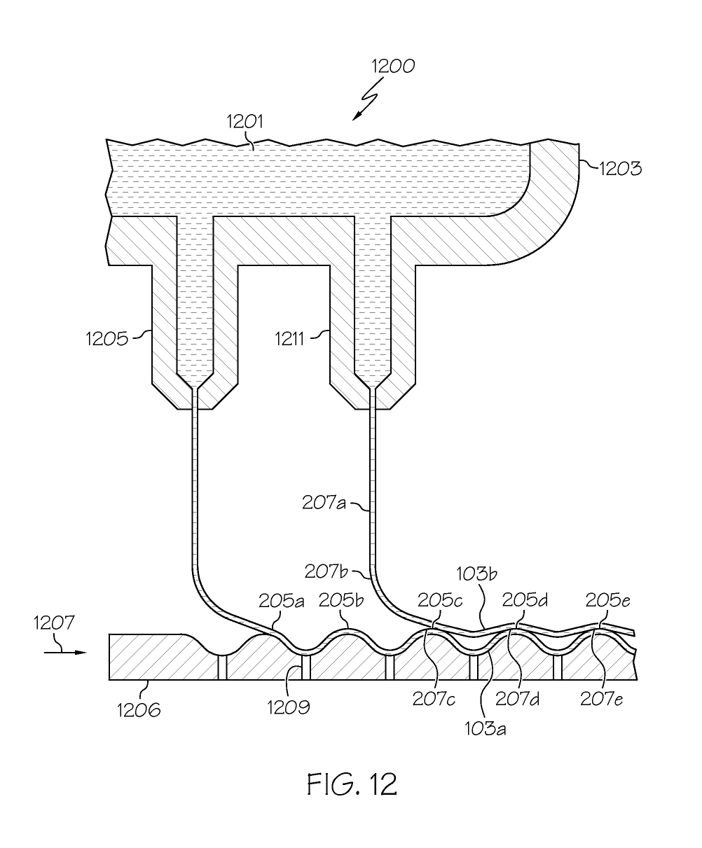

FIG. 12 illustrates one example method of making the glass vacuum insulating panel 101 with the understanding that similar methods may be carried out to form any of the glass vacuum insulated panels in accordance with the disclosure. As shown, the method may include use of a slot draw apparatus 1200 although other techniques may be provided such as fusion draw or other glass forming techniques. Moreover, various types of glass may be used in accordance with aspects of the disclosure. For example, transparent, translucent or opaque glass sheets may be used in some examples. Example glass compositions can comprise soda-lime silicate, borosilicate, aluminosilicate, boro-aluminosilicate and the like.

As shown in FIG. 12, the first sheet portion 103a can optionally be slot drawn from molten glass 1201 within a reservoir 1203 by way of a first slot draw device 1205. During the slot draw process, the mold 1206 may be moved in direction 1207 relative to the slot draw apparatus 1200. The second sheet portion 103b can likewise be drawn from the molten glass 1201 within the reservoir 1203 by way of a second slot draw device 1211. In one example, vacuum ports 1209 can help form the first sheet portion 103a in the desired shape. As shown, the attachment locations 207a-e sequentially contact the respective attachment locations 205a-e wherein the integral attachment can occur to form the integral fritless attachment areas 208.

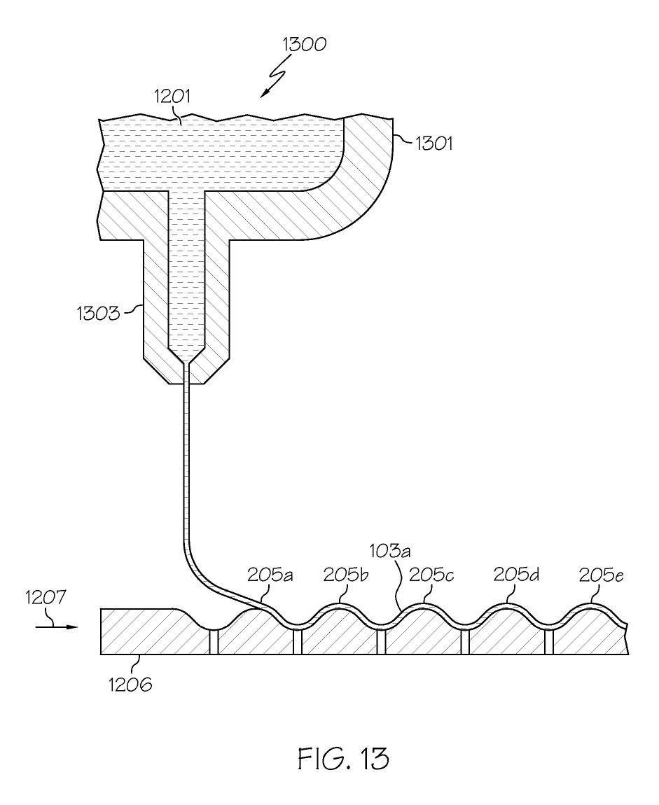

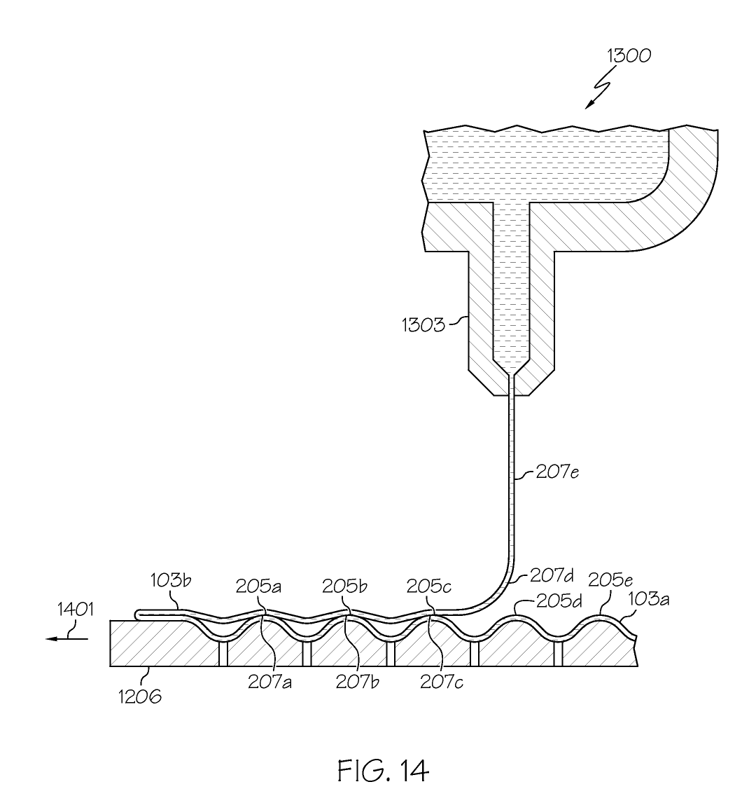

FIGS. 13 and 14 illustrate another example method of making the glass vacuum insulating panel 101 with the understanding that similar methods may be carried out to form any of the glass vacuum insulated panels in accordance with the disclosure. As shown in FIG. 13, the first sheet portion 103a can first be slot drawn from molten glass 1201 within a reservoir 1301 of a slot draw apparatus 1300 by way of a first slot draw device 1303. During the slot draw process, the mold 1206 may be moved in direction 1207 relative to the slot draw apparatus 1300. As shown in FIG. 14, after forming the first sheet portion 103a, the mold 1206 may move an opposite direction 1401 relative to the slot draw apparatus 1300 such that the drawn sheet of glass is folded over itself to form the second sheet portion 103b. As shown, the attachment locations 207a-e sequentially contact the respective attachment locations 205a-e wherein the integral attachment can occur to form the integral fritless attachment areas 208.

FIGS. 12-14 demonstrate just illustrative example steps of making a glass vacuum insulating panel 101. FIG. 12 demonstrates a method including the step of providing at least one sheet of glass 103 including a first sheet of glass comprising the first sheet portion 103a with the first plurality of attachment locations and a second sheet of glass comprising the second sheet portion 103b with a second plurality of attachment locations. Likewise, FIGS. 13-14 demonstrate a method including the step of providing at least one sheet of glass 103 comprising a single sheet of glass with the second sheet portion 103b being folded over the first sheet portion 103a.

FIGS. 12-14 further illustrate the step of fritlessly engaging each of the first plurality of attachment locations to a corresponding one of the second plurality of attachment locations to form a plurality of integral fritless attachment areas 208 that are spaced apart in a pattern along a plane 201. As such, the first sheet portion 103a and the second sheet portion 103b are integrally attached to one another with an insulating space 203 sealed between the first sheet portion 103a and the second sheet portion 103b.

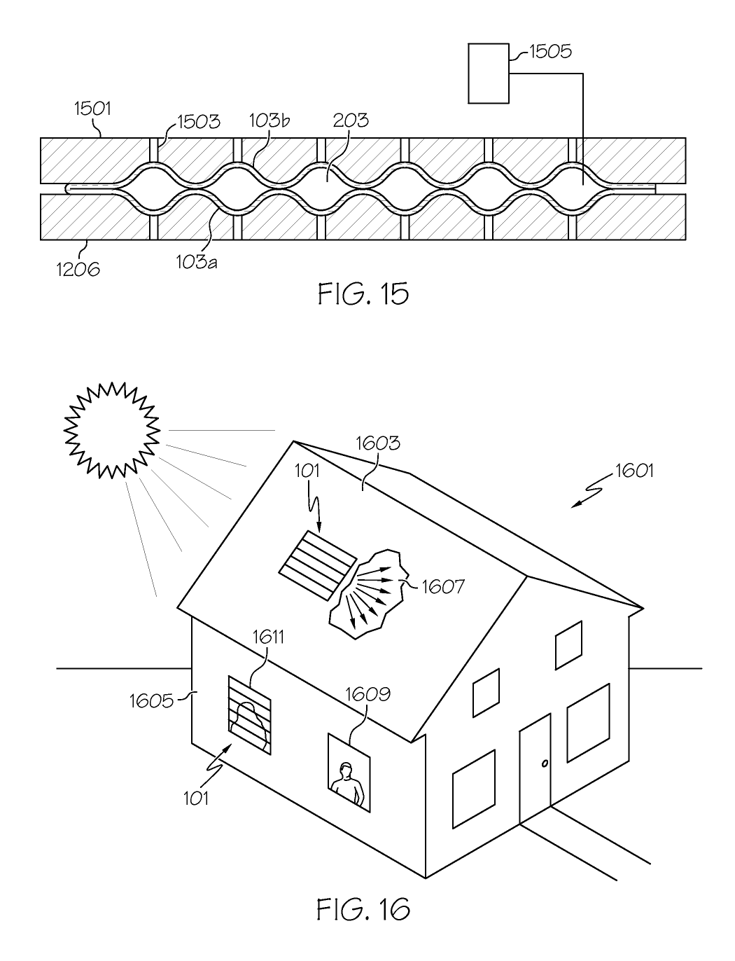

As shown in FIG. 15, an optional second mold 1501 may be provided. If provided, the second mold 1501 may be similar or identical to the first mold 1206. In one example, the molds may be pressed together to help integrate the attachment locations 205a-e of the first sheet portion 103a to the attachment locations 207a-e of the second sheet portion 103b. Optionally, the second mold 1501 may include vacuum ports 1503 the help draw the glass sheet portion against the mold surface. Furthermore, a pressure source 1505 may be configured to introduce air pressure into the insulating space 203 to help fully form the glass sheet portions within the mold.

Once fully formed, the glass panel may be provided with one or more of the above described characteristics. For instance, in one example, the method forms at least one of the first sheet portion 103a and the second sheet portion 103b with an outwardly facing surface defining a pattern of bulbous portions defined between a corresponding set of the plurality of integral attachment areas. The bulbous portions, if provided, can be formed as outwardly convex surface portion and/or as a pyramidal surface portion. For instance, a plurality of outwardly convex surface portions and/or pyramidal portions can extend along the width of the vacuum insulating panel with each outwardly convex surface portion and/or pyramidal portion at least partially defining a corresponding one of the plurality of insulating space segments. In another example, both of the first sheet portion and the second sheet portion each includes a plurality of outwardly convex surface portions and/or pyramidal portions extending along the width of the vacuum insulating panel, wherein each insulating space segment is substantially defined by a corresponding pair of outwardly convex surface portions and/or pyramidal portions of the first sheet portion and the second sheet portion.

It will be appreciated that the mold can be configured to provide various insulating space configurations. In one example, as described above, the method can optionally form the insulating space 203 as at least one insulating channel.

Once the glass panel is formed, the glass panel may be removed from the mold. In some optional examples, the glass panel may then be strength treated, e.g., by an ion exchange process or the like, to increase the structural integrity of the glass panel. Such strength treating can help the glass resist impact or other forces from environmental conditions.

The method can further include the step of providing the insulating space with an absolute pressure of less than about 10 kPa. For instance, as shown in FIG. 1, a vacuum device 107 may be designed to remove gas from the insulating space such that the insulating space 203 has less than one atmosphere of absolute pressure, wherein the glass vacuum insulating panel provides the insulating space 203 as an evacuated space. In one example, the vacuum device 107 can remove gas from the insulating space 203 until there is an absolute pressure of less than about 10 kPa, such as from about 1×10⁻¹⁰ Pa to about 10 kPa, such as from about 1×10⁻⁷ Pa to about 4 kPa, such as from about 1 kPa to about 4 kPa such as about 3.3 kPa. Reducing the pressure within the insulating space 203 can help prevent conduction or convection between the first sheet portion 103a and the second sheet portion 103b.

The method can further include the step of hermetically sealing the insulating space with the absolute pressure of less than about 10 kPa, wherein the insulating space contains essentially no amount of discharge or ionizable gas. For example, once the desired pressure is achieved in the insulating space 203 by the vacuum device 107, the evacuation port 105 can be hermetically sealed without backfilling the insulating space 203 with an amount of discharge or ionizable gas that would permit gas within the insulating space to discharge light with an electrode. In some examples, the evacuation port 105 can be hermetically sealed without a substantial amount, such as no amount, of any gas backfilling the insulating space after conducting the evacuation procedure. In such examples, the evacuation port 105 can be immediately hermetically sealed with substantially the same pressure provided after application of the vacuum device. As such, the process can include an evacuation step that does not include a backfilling step with another gas prior to hermetically sealing the glass vacuum insulating panel.

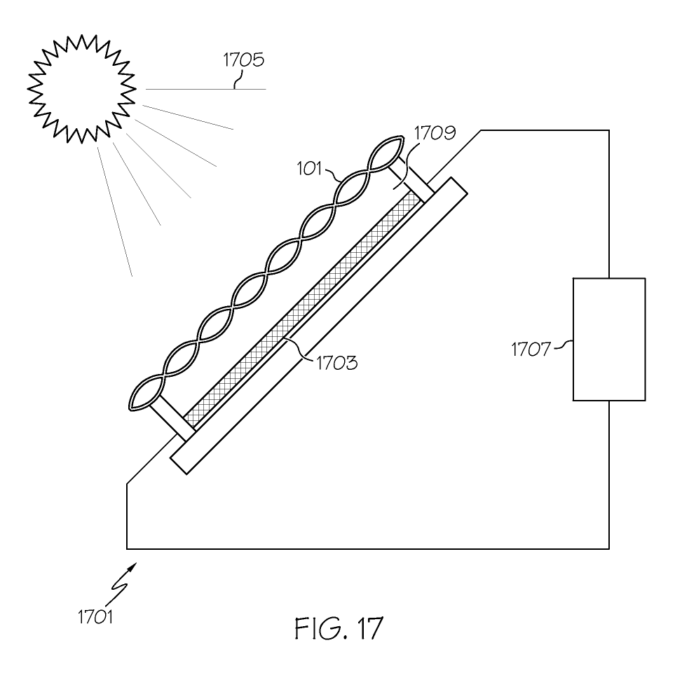

The glass vacuum insulating panels of the disclosure can be used in a wide variety of applications. Potential applications of the glass vacuum insulating panel are shown in FIGS. 16 and 17 although the glass panels may have other applications in further examples. Moreover, while FIGS. 16 and 17 illustrate application of the glass vacuum insulating panel 101 of FIGS. 1 and 2, similar or identical applications may be used with other glass panels set forth in the disclosure.

In one example, the glass vacuum insulating panel may be used with a housing structure. Housing structures can comprise dwellings such as townhomes, condominiums, single family homes, etc. In further example, housing structures can comprise agricultural housing structures such as greenhouses. In such examples, the glass vacuum insulating panel is configured to permit light to pass through the glass vacuum insulating panel into an interior area of the housing structure. Optionally, the glass vacuum insulating panel can be configured to substantially obscure an image being viewed through the glass vacuum insulating panel.

In further examples, the housing structure may comprise a food container, such as an insulating container to help keep items (e.g., food, beverages, medicines, cultures or other lab materials) at a different temperature than ambient temperature. For example, the insulating container can help maintain items at a higher temperature than ambient temperature. In some examples, the insulating container may be designed to receive items already heated and help insulate the heated items to reduce heat transfer from the heated items to the ambient environment. In addition or alternatively, the insulating container may be provided with a heating element to help heat the items or replace heat lost to the ambient environment. In further examples, the insulating container can help maintain items at a lower temperature than ambient temperature. In some examples, the insulating container may be designed to receive items already cooled and help insulate the cooled items to reduce heat transfer from the ambient environment to the cooled items. In addition or alternatively, the insulating container may be provided with a cooling element to help cool the items or remove heat transferred to the cooled items from the ambient environment.

For illustration purposes, FIG. 16 illustrates a housing structure comprising a dwelling 1601 including the glass vacuum insulating panel 101. As shown, the housing structure can include a wall that may be considered a roof, vertical wall or the like. In one example, the glass vacuum insulating panel 101 may be installed within the wall comprising the roof 1603 of the housing structure. In another example, glass vacuum insulating panel 101 is installed within a vertical wall 1605 of the housing structure. In both examples, the glass vacuum insulating panel 101 can permit light to enter through the wall wherein an interior area 1607 of the housing structure is at least partially insulated by the glass vacuum insulating panel 101.

As shown in FIG. 16, an image can be shown through a window 1609 with a typical glass configuration. As shown by window 1611 of FIG. 16, certain examples of the disclosure can substantially obscure the image that would normally be shown through the window. As such, in some examples, the glass vacuum insulating panel may act to substantially obscure an image as well facilitate insulation of the interior area 1607. Obscuring an image may have application as a privacy panel that allows light to pass through the panel while obscuring objects from being seen through the panel.

FIG. 17 illustrates the glass vacuum insulating panel 101 being installed as part of a solar absorber apparatus 1701. As shown, the solar absorber apparatus 1701 can include an absorber device 1703 configured to absorb solar energy 1705. The absorber device 1703 can be at least partially insulated with the glass vacuum insulating panel 101. A heat transfer device 1707 can also be installed and configured to remove absorbed energy from the absorber device 1703. In one example, the absorber device can comprise heat transfer pipes that may be designed to absorb energy radiated on the tubes. A single tube is shown although it will be understood that a plurality of tubes can be aligned in a row along the length “L” of the glass vacuum insulated panel. In such an example, the tubes are oriented parallel to one another within an insulated space 1709. As the tubes need not be separately encapsulated in glass tubes, the tubes may be aligned next to each other in a compact fashion to more effectively absorb solar energy. Moreover, the glass vacuum insulating panel 101 allows heat to be trapped within the insulated space 1709, thereby providing further heat transfer opportunities to the absorber device 1703 by radiation from the sun, or indirectly by conduction, convection or radiation from other surfaces or gas within the insulated space 1709.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A glass vacuum insulating panel comprising:
at least one sheet of glass including a first sheet portion with a first plurality of attachment locations and a second sheet portion with a second plurality of attachment locations, wherein the first sheet portion and the second sheet portion each extend along a plane of the glass vacuum insulating panel; and
an insulating space hermetically sealed between the first sheet portion and the second sheet portion, wherein the insulating space includes an absolute pressure of less than about 10 kPa and contains essentially no amount of discharge or ionizable gas within the insulating space, and each of the first plurality of attachment locations is fritlessly attached to a corresponding one of the second plurality of attachment locations to form a plurality of integral fritless attachment areas that are spaced apart in a pattern along the plane of the glass vacuum insulating panel.

2. The glass vacuum insulating panel of claim 1, wherein each of the plurality of integral fritless attachment areas extends as an elongated segment area along the plane of the glass vacuum insulating panel.

3. The glass vacuum insulating panel of claim 2, wherein each elongated segment area is substantially linear.

4. The glass vacuum insulating panel of claim 1, wherein each of the plurality of integral fritless attachment areas comprises a point area.

5. A housing structure including the glass vacuum insulating panel of claim 1, wherein the housing structure further comprises:
a wall including the glass vacuum insulating panel, wherein an interior area of the housing structure is at least partially insulated by the glass vacuum insulating panel.

6. A solar absorber apparatus including the glass vacuum insulating panel of claim 1, wherein the solar absorber apparatus further comprises:
an absorber device configured to absorb solar energy, wherein the absorber device is at least partially insulated with the glass vacuum insulating panel; and
a heat transfer device configured to remove absorbed energy from the absorber device.

7. A glass vacuum insulating panel comprising:
at least one sheet of glass including a first sheet portion with a first plurality of attachment locations and a second sheet portion with a second plurality of attachment locations, wherein the first sheet portion and the second sheet portion each extend along a plane of the glass vacuum insulating panel; and
an insulating space hermetically sealed between the first sheet portion and the second sheet portion, wherein the insulating space includes an absolute pressure of less than about 10 kPa and contains essentially no amount of discharge or ionizable gas within the insulating space, and each of the first plurality of attachment locations is attached to a corresponding one of the second plurality of attachment locations to form a plurality of integral attachment areas that are spaced apart in a pattern along the plane of the glass vacuum insulating panel, and at least one of the first sheet portion and the second sheet portion includes at least one outwardly facing nonplanar surface portion at each integral attachment area.

8. The glass vacuum panel of claim 7, wherein each of the first plurality of attachment locations and the corresponding one of the second plurality of attachment locations converge toward one another to form the corresponding integral attachment area.

9. The glass vacuum insulating panel of claim 7, wherein the insulating space comprises at least one insulating space channel.

10. The glass vacuum insulating panel of claim 7, wherein the plurality of integral attachment areas are each fritless.

11. The glass vacuum insulating panel of claim 7, wherein at least one of the first sheet portion and the second sheet portion includes an outwardly facing surface including the outwardly facing nonplanar surface portions, wherein the outwardly facing surface defines a pattern of bulbous portions defined between a corresponding set of the plurality of integral attachment areas.

12. A housing structure including the glass vacuum insulating panel of claim 7, wherein the housing structure further comprises:
a wall including the glass vacuum insulating panel, wherein an interior area of the housing structure is at least partially insulated by the glass vacuum insulating panel.

13. A solar absorber apparatus including the glass vacuum insulating panel of claim 7, wherein the solar absorber apparatus further comprises:
an absorber device configured to absorb solar energy, wherein the absorber device is at least partially insulated with the glass vacuum insulating panel; and
a heat transfer device configured to remove absorbed energy from the absorber device.

14. A method of making a glass vacuum insulating panel comprising the steps of:
(I) providing at least one sheet of glass including a first sheet portion with a first plurality of attachment locations and a second sheet portion with a second plurality of attachment locations;
(II) fritlessly engaging each of the first plurality of attachment locations to a corresponding one of the second plurality of attachment locations to form a plurality of integral fritless attachment areas that are spaced apart in a pattern along a plane such that the first sheet portion and the second sheet portion are integrally attached to one another with an insulating space sealed between the first sheet portion and the second sheet portion;
(III) providing the insulating space with an absolute pressure of less than about 10 kPa; and
(IV) hermetically sealing the insulating space with the absolute pressure of less than about 10 kPa, wherein the insulating space contains essentially no amount of discharge or ionizable gas.

15. The method of claim 14, wherein the method forms at least one of the first sheet portion and the second sheet portion with an outwardly facing surface defining a pattern of bulbous portions defined between a corresponding set of the plurality of integral attachment areas.

16. The method of claim 15, wherein the method forms each of the bulbous portions as an outwardly convex surface portion.

17. The method of claim 15, wherein the method forms each of the bulbous portions as a pyramidal surface portion.

18. The method of claim 15, wherein the method forms the insulating space as at least one insulating channel.

19. A method of making a housing structure including the method of making a glass vacuum insulating panel of claim 14, further comprising the steps of:
providing a wall; and
installing the glass vacuum insulating panel with respect to the wall, wherein an interior area of the housing structure is at least partially insulated by the glass vacuum insulating panel.

20. A method of making a solar absorber apparatus including the method of making a glass vacuum insulating panel of claim 14, further comprising the steps of:
providing an absorber device configured to absorb solar energy;
at least partially insulating the absorber device with the glass vacuum insulating panel; and
operably connecting a heat transfer device to the absorber device such that the heat transfer device is configured to remove absorbed energy from the absorber device.
